(19) United States
(12) Patent Application Publication
(10) Pub. No.: US 2018/0129184 A1
(43) Pub. Date: May 10, 2018

(54) CONTROL DEVICE, ROBOT, AND ROBOT SYSTEM

(71) Applicant: Seiko Epson Corporation, Tokyo (JP)

(72) Inventors: Yasuhiro SHIMODAIRA, Matsumoto (JP); Junya UEDA, Azumino (JP)

(21) Appl. No.: 15/806,719

(22) Filed: Nov. 8, 2017

(30) Foreign Application Priority Data
Nov. 10, 2016 (JP) 2016-219470

(51) Int. Cl. G05B 19/401; B25J 13/08; B25J 9/16

(52) U.S. Cl. CPC G05B 19/401; B25J 13/085; B25J 9/1694; G05B 2219/45091; G05B 2219/39529; G05B 2219/45064; B25J 9/1692

(57) ABSTRACT

A control device includes a processor that is configured to execute computer-executable instructions so as to control a robot that includes a robot arm including a force detector, wherein the processor is configured to reset the force detector after moving the robot arm at a first speed, and subsequently moves the robot arm at a second speed faster than the first speed and performs force control based on an output from the force detection unit.

### BACKGROUND

### 1. Technical Field

The present invention relates to a control device, a robot, and a robot system.

### 2. Related Art

In the related art, industrial robots including robot arms and end effectors mounted on tip ends of the robot arms have been developed.

As such a robot, for example, JP-A-2015-182164 discloses a robot that includes a robot arm, a force sensor, and a control unit controlling an operation of the robot arm. In the robot, the control unit performs force control based on a detection result from the force sensor.

In the robot disclosed in JP-A-2015-182164, initialization of the force sensor is performed to improve detection precision of the force sensor. Further, in the robot disclosed in JP-A-2015-182164, to shorten a cycle time, the above-described initialization of the force sensor is performed while the robot arm is moving at a uniform speed.

However, in the robot including the control unit disclosed in JP-A-2015-182164, the cycle time can be shortened. However, when a speed of the robot arm is fast, there is a problem that an influence of vibration associated with movement of the robot arm is not sufficiently excluded and it is difficult to improve detection precision of the force sensor.

### SUMMARY

An advantage of some aspects of the invention is to solve the problem described above, and the invention can be implemented as the following configurations.

A control device according to an aspect of the invention controls driving of a robot that includes a robot arm including a force detector. The control device includes a processor that is configured to execute computer-executable instructions so as to control a robot that includes a robot arm including a force detector, wherein the processor is configured to reset the force detector after moving the robot arm at a first speed, and subsequently moves the robot arm at a second speed faster than the first speed and performs force control based on an output from the force detection unit.

In the control device according to the aspect of the invention, it is possible to shorten a cycle time of a work of changing an operation performed based on the force control or information regarding a force and it is possible to improve detection precision by the force detector. Thus, it is possible to appropriately drive the robot.

Here, the “reset” means that a current force output value output from the force detector is set to a predetermined value (for example, zero). In other words, for example, the “reset” means that an influence of gravity of the weight of a target object, a change in an attitude of the robot arm, or the like or an influence of drift by a leakage current of the force detection circuit or thermal expansion of a force detector casing is lost or decreased.

In the control device according to the aspect of the invention, it is preferable that the second speed is equal to or greater than 50 mm/s.

With this configuration, it is possible to shorten the cycle time.

In the control device according to the aspect of the invention, it is preferable that the first speed is equal to or less than 20 mm/s.

With this configuration, it is possible to further improve the detection precision by the force detector.

In the control device according to the aspect of the invention, it is preferable that the second speed is equal to or greater than 200 mm/s.

With this configuration, it is possible to shorten the cycle time.

In the control device according to the aspect of the invention, it is preferable that the first speed is equal to or less than 80 mm/s.

With this configuration, it is possible to further improve the detection precision by the force detector.

In the control device according to the aspect of the invention, it is preferable that the second speed is 2.5 times or more the first speed.

With this configuration, it is possible to further shorten the cycle time and it is possible to further improve the detection precision by the force detector.

In the control device according to the aspect of the invention, it is preferable that the second speed is 10.0 times or more the first speed.

With this configuration, it is possible to further shorten the cycle time and it is possible to further improve the detection precision by the force detector.

In the control device according to the aspect of the invention, it is preferable that the processor is configured to perform control such that the robot holds a target object before resetting the force detection unit.

In this way, by resetting the force detector after holding the target object and lifting up the target object at the first speed, it is possible to shorten the cycle time and improve the detection precision by the force detector, compared to a case in which the force detector is reset before the target object is held or a case in which the force detector is reset after the target is held and moved at the second speed.

Here, the “holding” of the target object has meanings including grasping or adsorbing the target object.

In the control device according to the aspect of the invention, it is preferable that the processor is configured to perform the movement of the robot arm at the first speed and the movement of the robot arm at the second speed according to each position control.

With this configuration, for example, it is possible to appropriately move the tip end of the robot arm from a current location to a desired location.

Here, in the present specification, the “position control” includes speed control.

In the control device according to the aspect of the invention, it is preferable that the processor is configured to perform the force control without stopping the robot arm after moving the robot arm at the second speed.

With this configuration, it is possible to shorten the cycle time.

In the control device according to the aspect of the invention, it is preferable that the processor is configured to perform control such that an attitude of a tip end of the robot arm at the time of resetting the force detector is the same as an attitude of the tip end of the robot arm at the time of starting the force control.

With this configuration, it is possible to further improve the detection precision by the force detector and it is possible to more appropriately drive the robot.

In the control device according to the aspect of the invention, it is preferable that the processor is configured to perform gravity compensation of the force detector when an attitude of a tip end of the robot arm at the time of resetting the force detector is different from an attitude of the tip end of the robot arm at the time of starting the force control.

With this configuration, even when there is a difference in an attitude of the tip end of the robot between the time of the resetting and the time of starting the force control, it is possible to shorten the cycle time.

In the control device according to the aspect of the invention, it is preferable that the processor is configured to reset the force detector based on one command, and subsequently move the robot arm at the second speed faster than the first speed and perform the force control based on an output from the force detector.

In this way, by performing the plurality of processes (the resetting process, the moving process at the second speed, and the process of performing the force control) with one command, it is possible to improve readability and perform the plurality of processes simply and optimally.

A robot according to an aspect of the invention is controlled by the control device according to the aspect of the invention.

In the robot according to the aspect of the invention, it is possible to shorten the cycle time and it is possible to appropriately perform a desired operation.

A robot system according an aspect of the invention includes: the control device according to the aspect of the invention; and a robot that is controlled by the control device and includes a robot arm including a force detector.

In the robot system according to the aspect of the invention, it is possible to shorten the cycle time under the control of the control device and it is possible to cause the robot to appropriately perform a desired operation.

### BRIEF DESCRIPTION OF THE DRAWINGS

The invention will be described with reference to the accompanying drawings, wherein like numbers reference like elements.

FIG. 1 is a schematic side view illustrating a robot system according to a first embodiment of the invention.

FIG. 2 is a diagram illustrating a system configuration of the robot system illustrated in FIG. 1.

FIG. 3 is a diagram illustrating an example of a target trajectory of a robot illustrated in FIG. 1.

FIG. 4 is a flowchart illustrating a work of the robot illustrated in FIG. 1.

FIG. 5 is a schematic side view illustrating a robot system according to a second embodiment of the invention.

FIG. 6 is a diagram illustrating an example of a target trajectory of a robot illustrated in FIG. 5.

FIG. 7 is a flowchart illustrating a work of the robot illustrated in FIG. 5.

FIG. 8 is a schematic diagram illustrating an attitude of an end effector in step S24 of FIG. 7.

FIG. 9 is a schematic diagram illustrating an attitude of the end effector in step S25 of FIG. 7.

### DESCRIPTION OF EXEMPLARY EMBODIMENTS

Hereinafter, a control device, a robot, and a robot system according to the invention will be described in detail based on a preferred embodiment illustrated in the appended drawings.

### First Embodiment

### Robot System

First, a first embodiment of the invention will be described.

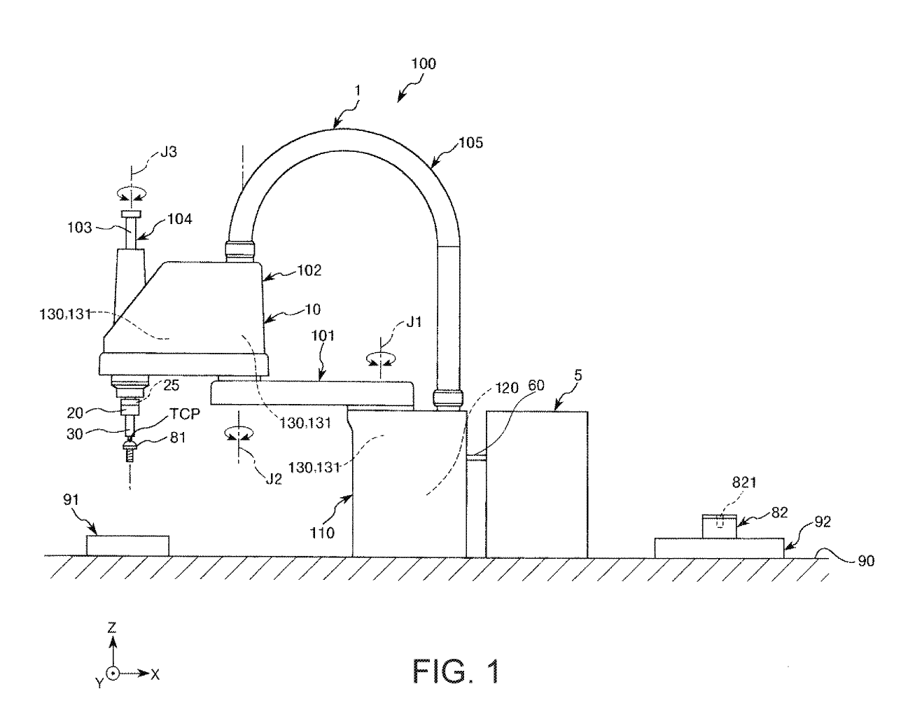

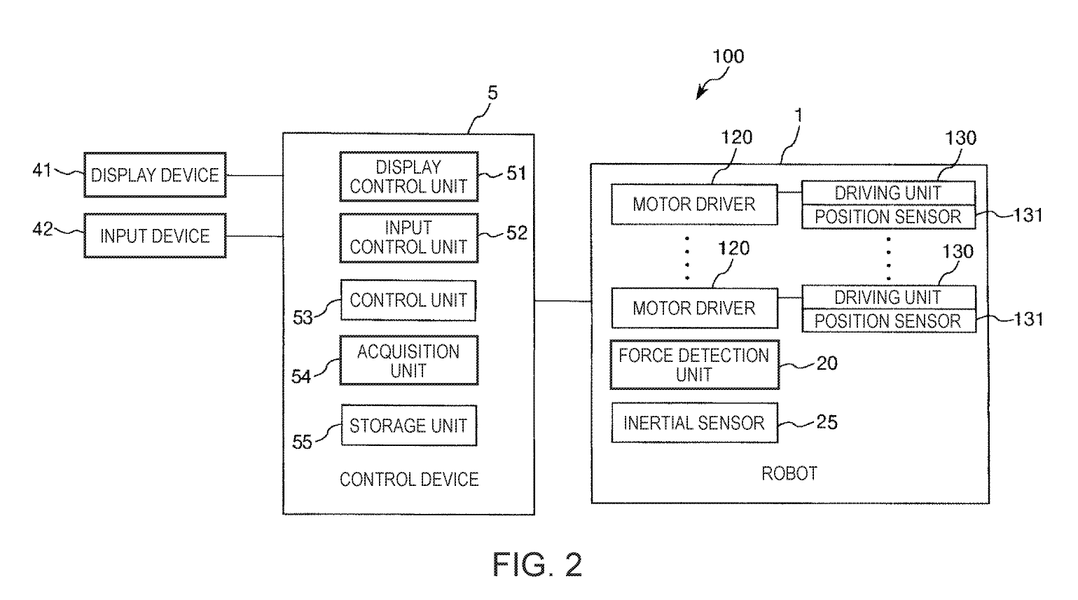

FIG. 1 is a schematic side view illustrating a robot system according to a first embodiment of the invention. FIG. 2 is a diagram illustrating a system configuration of the robot system illustrated in FIG. 1. Hereinafter, in FIG. 1, the upper side is referred to as an “upper” and the lower side is referred to as a “lower” to facilitate the description. In FIG. 1, the base side is referred to as a “base end” and an opposite side (an end effector side) is referred to as a “tip end”. In FIG. 1, X, Y, and Z axes are illustrated as three axes perpendicular to each other to facilitate the description. Hereinafter, a direction parallel to the X axis referred to as an “X axis direction”, a direction parallel to the Y axis is referred to as a “Y axis direction”, and a direction parallel to the Z axis is referred to as a “Z axis direction”. Hereinafter, a tip end side of each arrow illustrated in the drawing is referred to as a “+ (positive)” and a base end side of each arrow is referred to as a “− (negative)”. In FIG. 1, the upper and lower directions are referred to as a “vertical direction” and the right and left directions are referred to as a “horizontal direction”. In the present specification, the “horizontal” also includes a case of inclination equal to or less than 5° with respect to the horizontal. Similarly, in the present specification, the “vertical” also includes a case of inclination equal to or less than 5° with respect to the vertical.

The robot system 100 illustrated in FIG. 1 includes a robot 1 and a control device 5 that controls driving of the robot 1.

### Robot

The robot 1 illustrated in FIG. 1 is a so-called horizontally articulated robot (SCARA robot). The robot 1 includes a base stand 110, a robot arm 10 connected to the base stand 110, and a lead wiring unit 105. The robot arm 10 includes a first arm 101, a second arm 102, a work head 104, an end effector 30, a force detection unit 20, and an inertial sensor 25. As illustrated in FIGS. 1 and 2, the robot 1 includes a plurality of driving units 130 that generate power for driving the robot arm 10, a plurality of position sensors 131 (angle sensors), and a plurality of motor drivers 120.

For example, the robot 1 is used in a manufacturing process of manufacturing precision equipment or the like and can grasp and transport a target object such as precision equipment, a component, or the like under the control of the control device 5.

The base stand 110 is a portion for fitting the robot 1 in any installation place 90. The installation place of the base stand 110 is not particularly limited. Examples of the installation place include a floor, a wall, a ceiling, and a movable carriage.

The first arm 101 is connected to an upper end portion of the base stand 110. The first arm 101 is rotatable about a rotation axis J1 which is a first axis in the vertical direction with respect to the base stand 110.

The second arm 102 is connected to a tip end of the first arm 101. The second arm 102 is rotatable about a rotation axis J2 which is a second axis in the vertical direction with respect to the first arm 101.

The work head 104 is disposed in the tip end of the second arm 102. The work head 104 includes a spline shaft 103 inserted into a spline nut and a ball screw nut (neither of which is illustrated) disposed coaxially at the tip end of the second arm 102. The spline shaft 103 is rotatable about an axis J3 (which is a third axis) with respect to the second arm 102 and is movable (moves up and down) in the up and down directions.

The driving unit 130 that includes a motor (not illustrated) generating a driving force for driving (rotating) the first arm 101 and a reducer (not illustrated) reducing the driving force of the motor and the position sensor 131 detecting a rotation state (rotation state) of the first arm 101 with respect to the base stand 110 are installed in the base stand 110. Similarly, the driving unit 130 driving the second arm 102, the position sensor 131 detecting a rotation state of the second arm 102, the driving unit 130 driving the spline shaft 103, and the position sensor 131 detecting a rotation state of the spline shaft 103 are installed in the second arm 102. That is, the robot 1 includes the three driving units 130 and the three position sensors 131.

For example, a servo motor such as an AC servo motor or a DC servo motor can be used as the motor included in the driving unit 130. For example, a planetary gear reducer or a wave gear device can be used as the reducer. For example, an encoder or a rotary encoder can be used as the position sensor 131 (angle sensor).

Each driving unit 130 is controlled by the control device 5 via a plurality of electrically connected motor drivers 120 (in the embodiment, three motor drivers 120). In the embodiment, each motor driver 120 is contained in the base stand 110.

As illustrated in FIG. 1, the inertial sensor 25 is installed at the tip end (lower end) of the spline shaft 103. The inertial sensor 25 may be installed in a portion other than the tip end of the spline shaft 103.

In the embodiment, a three-axis angular velocity sensor detecting angular velocities around three axes (x, y, and z axes) at the tip end of the spline shaft 103 is utilized as the inertial sensor 25. For example, a three-axis acceleration sensor detecting acceleration in three axis directions can be used as the inertial sensor 25. For example, an angular velocity sensor detecting an angular velocity around one axis or two axes of the three axes or an acceleration sensor detecting acceleration around one axis or two axes of the three axes may be utilized as the inertial sensor 25.

As illustrated in FIG. 1, the force detection unit 20 is fitted to be detachably mounted on the tip end (lower end) of the spline shaft 103.

The force detection unit 20 is a force detector (force sensor) that detects a force (including a moment) applied to the end effector 30. In the embodiment, a six-axis force sensor capable of detecting six components of translational force components Fx, Fy, and Fz in three axes (x, y, and z axes) direction perpendicular to each other and rotational force components (moments) Mx, My, and Mz around the three axes is utilized as the force detection unit 20. The force detection unit 20 outputs the detected force output values (force detection information) to the control device 5. The force detection unit 20 is not limited to the six-axis force sensor. For example, a three-axis force sensor or the like may be used.

As illustrated in FIG. 1, the end effector 30 is detachably fitted at the tip end (lower end) of the force detection unit 20. The end effector 30 is a device that performs a work on various target objects and has a function of holding a target object. Here, the “holding” of the target object has meanings including grasping or adsorbing a target object. In the embodiment, the end effector 30 has a mechanism capable of magnetizing a target object. Thus, as illustrated in FIG. 1, a screw 81 can be held by magnetizing the screw 81 as a target object. The end effector 30 may have a function of holding a target object. For example, the end effector 30 may include a hand grasping a target object or an adsorption mechanism adsorbing a target object.

The robot 1 which is an example of the robot according to the invention is controlled by the control device 5 to be described below. Therefore, it is possible to shorten a cycle time and appropriately perform a desired operation.

Hereinafter, the control device 5 will be described.

### Control Device

In the embodiment, for example, the control device 5 is configured with a personal computer (PC) that contains a central processing unit (CPU) being one example of a processor, a read-only memory (ROM) and a random access memory (RAM) being examples of a memory for storing computer-executable instructions. As illustrated in FIG. 1, the control device 5 is connected to the robot 1 via a wiring 60 or the like. The robot 1 and the control device 5 may be connected through wireless communication. In the embodiment, the control device 5 is separated from the robot 1 or may be contained in the robot 1.

As illustrated in FIG. 2, the control device 5 includes a display control unit 51, an input control unit 52, a control unit 53 (robot control unit), an acquisition unit 54, and a storage unit 55.

The display control unit 51 is connected to a display device 41 that includes a monitor (not illustrated) such as a display. The display control unit 51 is configured with, for example, a graphic controller and has a function of displaying various screens (for example, an operation window) on the monitor of the display device 41.

The input control unit 52 is connected to, for example, the input device 42 such as a mouse or a keyboard and has a function of receiving an input from the input device 42.

The input device 42 and the above-described display device 41 may be configured to be integrated. In this case, for example, a touch panel can be used.

The control unit 53 can be configured with a CPU or the like or can be realized by causing the CPU to execute various programs and has a function of controlling driving of each unit of the robot 1. The control unit 53 independently controls driving of the robot arm 10, the force detection unit 20, the inertial sensor 25, and the end effector 30.

The control unit 53 outputs a control signal to the each driving unit 130 and controls driving of the first arm 101, the second arm 102, and the spline shaft 103 included in the robot arm 10. The control unit 53 performs position control (including speed control) and force control on the robot 1 (the robot arm 10).

Specifically, the control unit 53 performs the position control to drive the robot arm 10 such that the tip end of the end effector 30 is moved along a target trajectory. More specifically, the control unit 53 controls driving of each driving unit 130 so that a position and an attitude of the end effector 30 become a position and attitude at a plurality of target points on the target trajectory (a target position and a target attitude). In the embodiment, the control unit 53 performs control based on position detection information (for example, a rotation angle or an angular velocity of a rotation axis of each driving unit 130) output from each position sensor 131. In the embodiment, for example, CP control or PTP control is performed as the position control.

The control unit 53 has a function of setting (generating) the target trajectory and setting (generating) a position and an attitude of the tip end of the end effector 30 or a speed (including an angular velocity) in movement in a direction along the target trajectory of the end effector 30.

The control unit 53 performs force control on the robot 1 such that the end effector 30 presses (comes into contact with) a target object with a target force (desired force). Specifically, the control unit 53 controls driving of each driving unit 130 such that a force (including a moment) acted on the end effector 30 becomes a target force (including a target moment). The control unit 53 controls driving of each driving unit 130 based on a force output value output from the force detection unit 20. In the embodiment, the control unit 53 sets impedance (a mass, a coefficient of viscosity, and an elastic coefficient) according to the force acted on the tip end of the end effector 30 as the force control and performs impedance control on each driving unit 130 such that the impedance is realized in a pseudo-manner.

The control unit 53 has a function of combining (synthesizing) a component (control amount) related to the above-described position control and a component (control amount) related to the force control and generating and outputting a control signal to drive the robot arm 10. Accordingly, the control unit 53 performs the force control, the position control, or hybrid control in which the force control and the position control are combined to operate the robot arm 10.

As described above, the control unit 53 controls driving of the end effector 30. In the embodiment, for example, the screw 81 is magnetized to hold the screw 81 or the magnetization is released to separate the screw 81 from the end effector 30.

The control unit 53 operates the force detection unit 20. For example, the control unit 53 resets the force detection unit 20. Here, the “reset” means that the current force output value output from the force detection unit 20 is set to a predetermined value (for example, zero). In other words, for example, the “reset” means that an influence of gravity of the weight of a target object, an attitude of the robot arm, or the like or an influence of drift by a leakage current or thermal expansion is lost or decreased.

The control unit 53 operates the inertial sensor 25 and performs vibration suppression control based on a detection result of the inertial sensor 25.

The acquisition unit 54 illustrated in FIG. 2 acquires detection results output from the force detection unit 20, the inertial sensor 25, and each position sensor 131.

The storage unit 55 illustrated in FIG. 2 has a function of storing data or a program causing the control unit 53 to perform various processes. For example, the storage unit 55 can store the target trajectory or detection results output from the force detection unit 20, the inertial sensor 25, and each position sensor 131.

The configuration of the robot system 100 has been described above simply. Next, an operation of the robot 1 based on the control of the control device 5 will be described while describing an example of a work by the robot system 100.

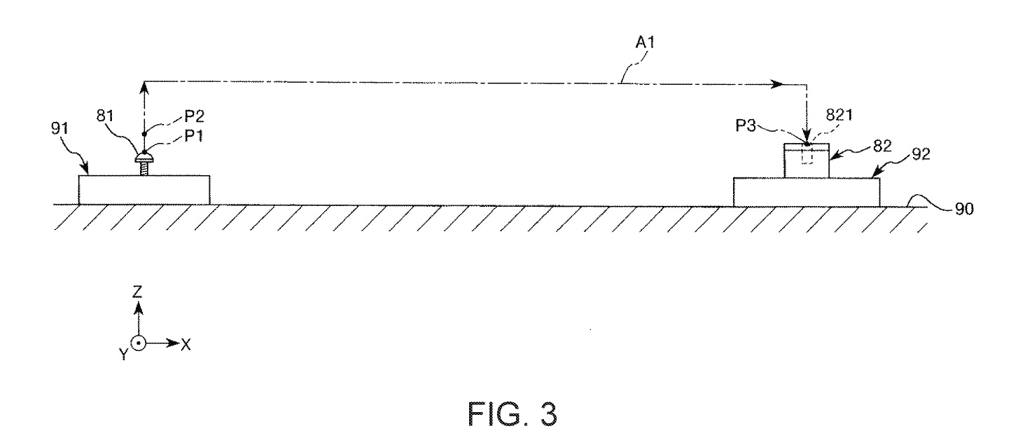

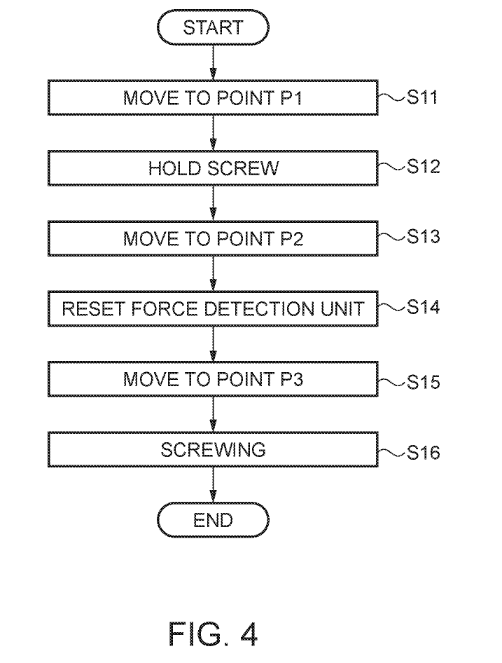

FIG. 3 is a diagram illustrating an example of a target trajectory of a robot illustrated in FIG. 1. FIG. 4 is a flowchart illustrating a work of the robot illustrated in FIG. 1.

Hereinafter, a screwing work of the robot 1 will be described as an example. Specifically, an example in which the robot 1 holds the screw 81 (a target object) from a supply stand 91, the screw 81 is transported onto a work stand 92 on which a member 82 that has a screw hole 821 is placed, and subsequently a screwing work of inserting the screw 81 into the screw hole 821 is performed will be described (see FIGS. 1 and 3).

A target trajectory A1 illustrated in FIG. 3 is a route along which a tool center point TCP which is the tip end of the end effector 30 of the robot 1 in the above-described screwing work is moved (see FIG. 1). In the above-described screwing work, the control device 5 holds the screw 81, subsequently, moves the tip end of the end effector 30 along the target trajectory A1 from the supply stand 91 in the +Z axis direction, subsequently moves the tip end of the end effector 30 in the +X axis direction, and moves the tip end of the end effector 30 in the −Z axis direction. Then, the screwing is performed. In the screwing work, the end effector 30 is moved without changing the attitude of the end effector 30.

A point P1 on the target trajectory A1 is a point at which the screw 81 on the supply stand 91 is held. A point P2 on the target trajectory A1 is a point at which the robot 1 lifts up the screw 81 and is a point at which the screw 81 is taken with the end effector 30 and the screw 81 is separated from the supply stand 91. A point P3 on the target trajectory A1 is a point at which the screw 81 is inserted into the screw hole 821 of the member 82.

For example, the target trajectory A1 may be a route generated with CAD data or the like or may be a route generated by direct teaching. The target trajectory A1 is stored in the storage unit 55, and thus driving of each unit of the robot 1 performed to move the tip end of the end effector 30 along the target trajectory A1 is assumed to be taught. The control unit 53 performs the above-described screwing work on the robot 1 based on a program that has a plurality of commands (operation commands).

Hereinafter, the screwing work of the robot 1 based on the control of the control device 5 will be described with reference to the work flow illustrated in FIG. 4.

First, the control unit 53 drives the robot arm 10 so that the tip end of the end effector 30 is located to the point P1 (step S11). The driving is performed through the position control.

Subsequently, the control unit 53 causes the end effector 30 to hold the screw 81 placed on the supply stand 91 (step S12). At this time, the force control based on a force output value output from the force detection unit 20 is performed.

Subsequently, the control unit 53 drives the robot arm 10 so that the tip end of the end effector 30 is located to the point P2 (step S13). That is, the control unit 53 lifts up the screw 81 from the supply stand 91 in the +Z axis direction and separates the screw 81 from the supply stand 91. The driving is performed through the position control. The movement of the tip end of the end effector 30 from the point P1 to the point P2 in step S13 is performed at a first speed V11 which is a relatively slow speed.

Subsequently, the control unit 53 resets the force detection unit 20 (step S14). At this time, preferably, the control unit 53 stops the driving of the robot arm 10 for only a predetermined time after moving the tip end of the end effector 30 to the point P2, and subsequently resets the force detection unit 20. Thus, it is possible to reduce an influence of vibration of the robot arm 10 in the resetting of the force detection unit 20. Therefore, it is possible to further improve detection precision of the force detection unit 20 in the work through the force control after step S14. For example, the stopping time is preferably equal to or greater than 0.01 s and equal to or less than 1.0 s and is more preferably equal to or greater than 0.1 s and equal to or less than 0.5 s. In particular, the stopping time in the embodiment is assumed to be 0.15 s. Thus, it is possible to suppress an influence on a cycle time to be small, and thus it is possible to more effectively reduce the influence of the vibration of the robot arm 10 in the resetting of the force detection unit 20.

Here, the above-described first speed V11 is not particularly limited. The first speed V11 is preferably equal to or less than 20 mm/s, more preferably equal to or less than 18 mm/s, and further more preferably equal to or less than 15 mm/s. Thus, it is possible to reduce the influence of the vibration of the robot arm 10 when the force detection unit 20 is reset. Therefore, it is possible to further improve the detection precision of the force detection unit 20 in the work through the force control after step S14.

For example, the first speed V11 is preferably equal to or greater than 0.1 mm/s and is more preferably equal to or greater than 1 mm/s. Thus, it is possible to suppress an influence of a time taken to perform an operation of lifting up the screw 81 on a cycle time to be small and accurately perform the operation.

Subsequently, the control unit 53 drives the robot arm 10 so that the tip end of the end effector 30 is located to the point P3 (step S15). That is, the control unit 53 drives the robot arm 10 so that the tip end of the end effector 30 is moved along the target trajectory A1, locates the tip end of the end effector 30 onto the work stand 92, and inserts the screw 81 into the screw hole 821. The driving along the target trajectory A1 is performed through the position control and the screw 81 is inserted into the screw hole 821 through the force control. Here, in the embodiment, the force detection unit 20 is reset in step S14. Therefore, it is possible to improve the detection precision of the force detection unit 20 in the work of inserting the screw 81 into the screw hole 821, and thus it is possible to perform the insertion work with high precision. In the embodiment, the impedance control is performed as the force control in the insertion of the screw 81 into the screw hole 821. Thus, when the screw 81 is inserted into the screw hole 821, it is possible to appropriately perform the insertion work in a relatively short time while suppressing or preventing an excessive force from being acted on the member 82.

The movement along the target trajectory A1 in step S15, that is, the movement of the tip end of the end effector 30 from the point P2 to the point P3 is performed at a second speed V21 faster than the first speed V11. The second speed V21 is not particularly limited. The second speed V21 is preferably equal to or greater than 50 mm/s, more preferably equal to or greater than 100 mm/s, and further more preferably equal to or greater than 250 mm/s. Thus, the cycle time can be further shortened. For example, the second speed V21 is preferably equal to or less than 4000 mm/s and is more preferably equal to or less than 1000 mm/s. Thus, it is possible to perform the operation more stably.

The second speed V21 is preferably 2.5 times or more the first speed V11, is more preferably 10.0 times or more, and is further more preferably 15.0 times or more. Thus, it is possible to more suitably obtain both the advantages of further shortening the cycle time and further improving the detection precision by the force detection unit 20. In particular, when the second speed V21 is 10.0 times or more, it is possible to further considerably and evenly obtain the above-described advantages.

In the embodiment, the force control is started without stopping the tip end of the end effector 30 after moving the tip end of the end effector 30 to the point P3 along the target trajectory A1 through the position control, and the screw 81 is inserted into the screw hole 821. In this way, in the embodiment, the control unit 53 performs the force control without stopping the robot arm 10 after moving the robot arm 10 at the second speed. Thus, it is possible to further shorten the cycle time.

Subsequently, when the screw 81 is inserted into the screw hole 821 through the force control, the control unit 53 controls the operation of the end effector 30 to perform the screwing work (step S16).

In this way, the screwing work by the robot 1 ends.

As described above, the control device 5 which is an example of a control device according to the invention controls driving of the robot 1 that includes the robot arm 10 including the force detection unit 20. The control device 5 includes the control unit 53 that resets the force detection unit 20 after moving the robot arm 10 at the first speed V11, and subsequently moves the robot arm 10 at the second speed V21 faster than the first speed V11 and performs the force control based on the output (the force output value) from the force detection unit 20. Since the control device 5 resets the force detection unit 20 after lifting up the screw 81 at the first speed V11 while holding the screw 81 as the target object, as described above, it is possible to improve the detection precision by the force detection unit 20. Therefore, it is possible to perform the subsequent screwing work with high precision through the force control. By moving a predetermined portion (more accurately, the tip end of the end effector 30) of the robot arm 10 at the second speed V21 faster than the first speed V11, it is possible to move the screw 81 onto the member 82. Therefore, it is possible to shorten the cycle time of a work of the robot 1. In this way, since the control device 5 can shorten the cycle time and improve the detection precision by the force detection unit 20, the driving of the robot 1 can be appropriately driven.

In particular, by setting the first speed V11 and the second speed V21 to be the above-described values, it is possible to more considerably improve the advantage of improving the detection precision by the force detection unit while shortening the cycle time. In Table 1 below, preferable combinations of the first speed V11 and the second speed V21 are exemplified.

TABLE 1

| | Second speed | | |
|---|---|---|---|
| | | 50 mm/s or | |
| | Less than | more and 4000 | Greater than |
| First speed | 50 mm/s | mm/s or less | 4000 mm/s |
| Less than 0.1 mm/s | C | B | C |
| 0.1 mm/s or more and | B | A | B |
| 20 mm/s or less | | | |
| Greater than 20 mm/s | C | B | C |

In Table 1, “A”, “B”, and “C” indicate evaluations based on the following evaluation references.

### Evaluation References

A: (1) the cycle time in the above-described screwing work is very fast and (2) a force output value from the force detection unit 20 when the tip end of the end effector 30 is moved at the first speed V11 and subsequently stopped is 0.3 N or less. As the force output value is closer to 0 (zero), it is indicated that the influence of the vibration of the robot arm 10 is smaller.

B: At least one of the foregoing (1) and (2) is less strict than the evaluation A.

C: At least one of the foregoing (1) and (2) is less strict than the evaluation B.

Here, in the evaluations A, B, and C, the cycle time is faster than in the related art and the influence of the vibration of the robot arm 10 is less than in the related art.

The first and second speeds preferably satisfy the following numerical ranges in accordance with work content or the like of the robot 1 in addition to the above-described numerical ranges. Specifically, a second speed V22 is not particularly limited. The second speed V22 is preferably equal to or greater than 200 mm/s, is more preferably equal to or greater than 300 mm/s, and is further more preferably equal to or greater than 500 mm/s. Thus, it is possible to further shorten the cycle time. In this case, a first speed V12 is not particularly limited. The first speed V12 is preferably equal to or less than 80 mm/s, is more preferably equal to or less than 70 mm/s, and furthermore preferably equal to or less than 60 mm/s. Thus, it is possible to reduce the influence of the vibration of the robot arm 10 when the force detection unit 20 is reset. Therefore, it is possible to further improve the detection precision by the force detection unit 20.

In Table 2 below, preferable combinations of the first speed V12 and the second speed V22 are exemplified.

TABLE 2

| | Second speed | | |
|---|---|---|---|
| | | 200 mm/s or | |
| | Less than | more and 4000 | Greater than |
| First speed | 200 mm/s | mm/s or less | 4000 mm/s |
| Less than 0.1 mm/s | F | E | F |
| 0.1 mm/s or more and | E | D | E |
| 80 mm/s or less | | | |
| Greater than 80 mm/s | F | E | F |

In Table 2, “D”, “E”, and “F” indicate evaluations based on the following evaluation references.

### Evaluation Reference

D: [3] the cycle time in the above-described screwing work is very fast and [4] a force output value from the force detection unit 20 when the tip end of the end effector 30 is moved at the first speed V12 and subsequently stopped is 0.3 N or less. As the force output value is closer to 0 (zero), it is indicated that the influence of the vibration of the robot arm 10 is smaller.

E: At least one of the foregoing [3] and [4] is less strict than the evaluation D.

F: At least one of the foregoing [3] and [4] is less strict than the evaluation E.

Here, in the evaluations D, E, and F, the cycle time is faster than in the related art and the influence of the vibration of the robot arm 10 is less than in the related art.

In accordance with the first speed V12 and the second speed V22, it is possible to obtain the same advantages as the combinations of the above-described first speed V11 and second speed V21. The combinations of the first speed V11 and the second speed V21 and the combinations of the first speed V12 and the second speed V22 can be set in accordance with, for example, work content of the robot 1, the shape or weight of a target object, or the like.

As described above, the control unit 53 performs control such that the screw 81 which is a “target object” is held by the robot 1 in step S12 before the force detection unit 20 is reset in step S13. Thus, after the screw 81 is held and lifted up at the first speed (the first speed V11 or the first speed V12), the force detection unit 20 can be reset. Compared to a case in which the force detection unit 20 is reset before the screw 81 is held or a case in which the force detection unit 20 is reset after the screw 81 is held and moved at the second speed (the second speed V21 or the second speed V22), it is possible to shorten the cycle time and improve the detection precision by the force detection unit 20.

As described above, the control unit 53 performs the movement of the robot arm 10 at the first speed in step S13 and the movement at the second speed in step S15 through the position control. Thus, it is possible to appropriately move the tip end of the end effector 30 from a current location (for example, the point P1 or P3) to a desired location (for example, the point P2 or P3).

Further, as described above, the control unit 53 performs the force control without stopping the robot arm 10 after moving the robot arm 10 at the second speed in step S15. Thus, it is possible to further shorten the cycle time. This is because the robot 1 includes the inertial sensor 25 and the control device 5 can perform vibration suppression control.

The control unit 53 performs control such that an attitude (an attitude at the point P2) of the tip end of the robot arm 10 at the time of resetting the force detection unit 20 is the same as an attitude (an attitude at the point P3) of the tip end of the robot arm 10 at the time of starting the force control. In this way, by resetting the force detection unit 20 when the attitude is the same as the attitude of the end effector 30 at the time of starting the force control, it is possible to particularly improve the detection precision by the force detection unit 20. Accordingly, it is possible to appropriately drive the robot 1. Therefore, it is possible to perform the screwing work with high precision.

As in the embodiment, in the robot 1 which is a horizontally articulated robot, the screwing work can be performed without changing the attitude of the end effector 30. Therefore, it is possible to easily reset the force detection unit 20 when the attitude is the same as the attitude of the end effector 30 at the time of starting the force control.

As described above, the control unit 53 drives the robot 1 based on a program that has a plurality of commands. In the embodiment, the control unit 53 resets the force detection unit 20 based on one command, and subsequently moves the robot arm 10 at the second speed faster than the first speed and performs the force control based on the output (the force output value) from the force detection unit 20. That is, the operations of the robot 1 in steps S14 and S15 are performed based on one command. In this way, by performing the plurality of processes (the resetting process, the moving process at the second speed, and the process of performing the force control) with one command, it is possible to improve readability (easy to read a program) and perform the plurality of processes simply and optimally.

The robot system 100 which is an example of the robot system according to the invention, as described above, includes the control device 5 and the robot 1 that is controlled by the control device 5 and includes the robot arm 10 including the force detection unit 20. In the robot system 100, it is possible to shorten the cycle time under the control of the control device 5 and it is possible to cause the robot 1 to appropriately perform a desired operation.

### Second Embodiment

Next, a second embodiment of the invention will be described.

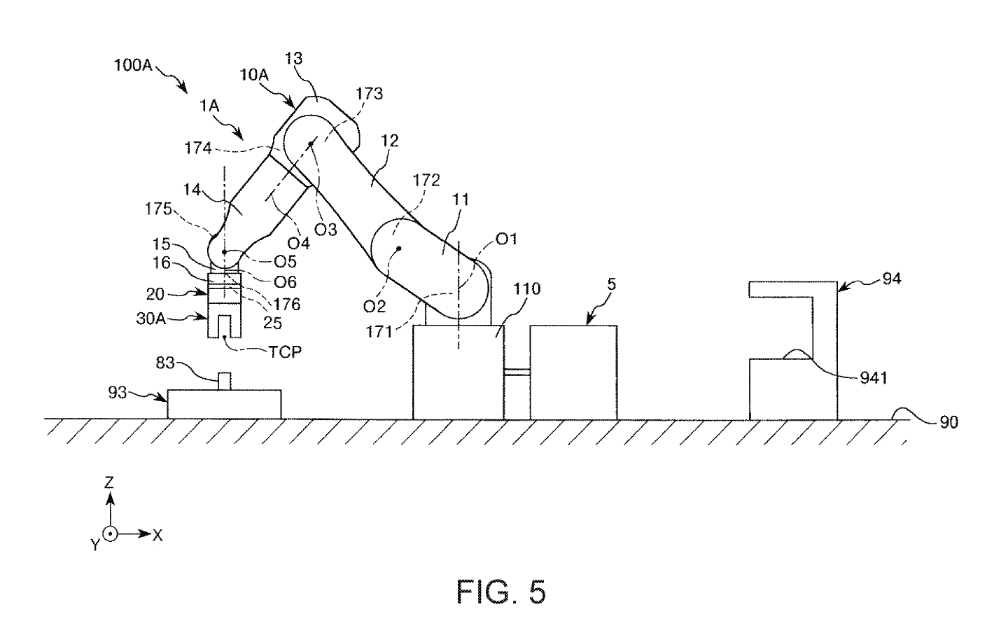

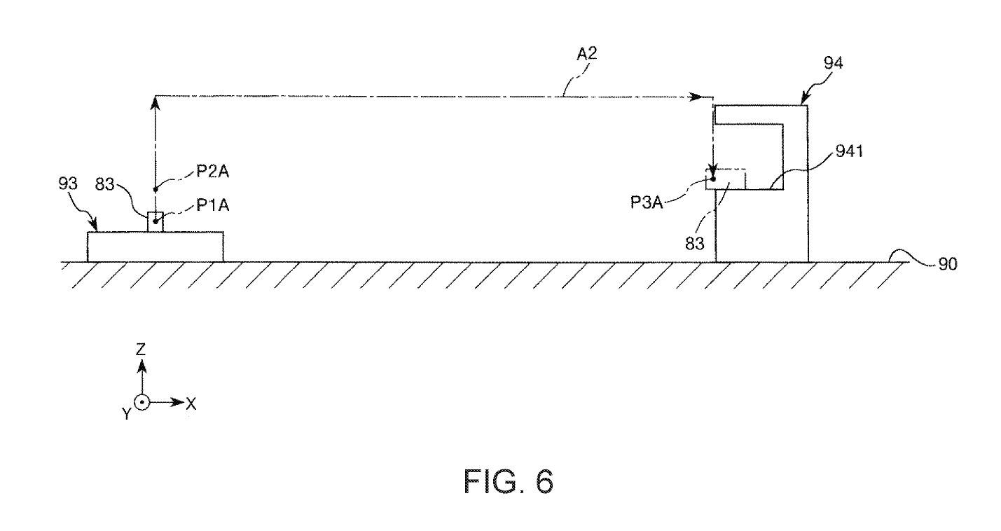

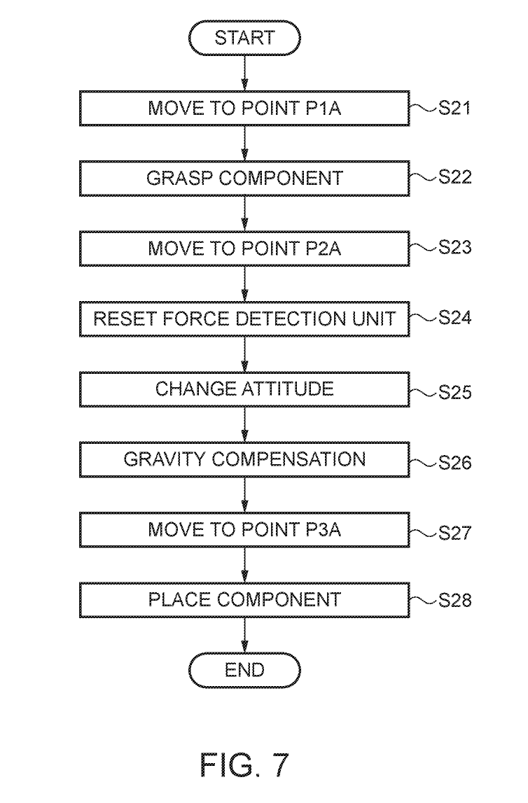

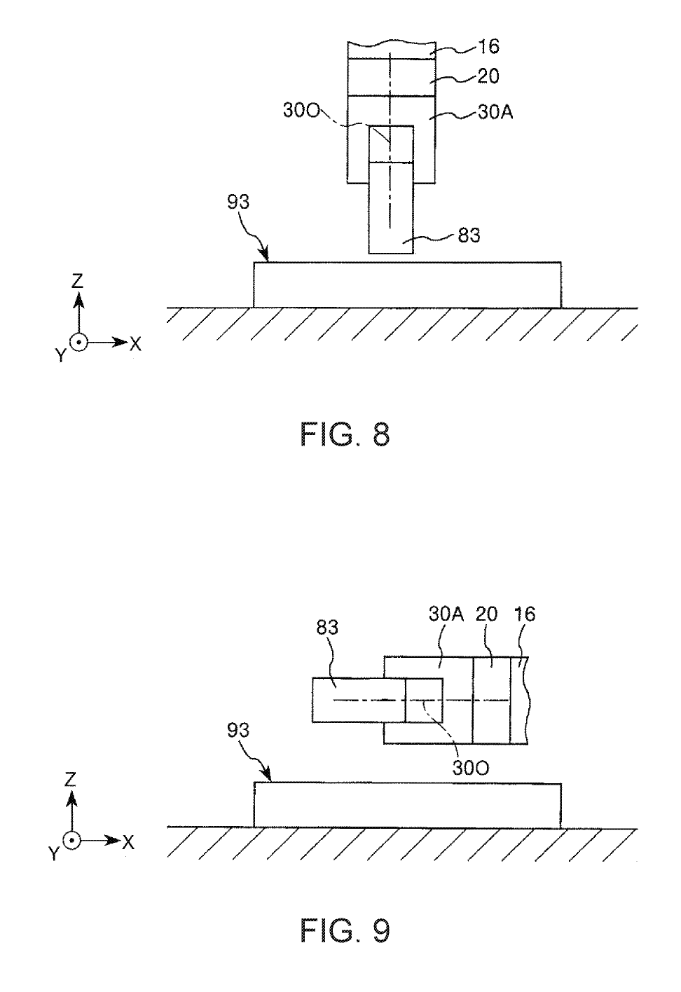

FIG. 5 is a schematic side view illustrating a robot system according to a second embodiment of the invention. FIG. 6 is a diagram illustrating an example of a target trajectory of a robot illustrated in FIG. 5. FIG. 7 is a flowchart illustrating a work of the robot illustrated in FIG. 5. FIG. 8 is a schematic diagram illustrating an attitude of an end effector in step S24 of FIG. 7. FIG. 9 is a schematic diagram illustrating an attitude of the end effector in step S25 of FIG. 7.

In the following description, differences between the present embodiment and the above-described embodiment will be mainly described. The same factors will not be described.

A robot 1A included in a robot system 100A illustrated in FIG. 5 is a so-called six-axis vertically articulated robot. The robot 1A includes a base stand 110 and the robot arm 10A.

As illustrated in FIG. 6, the robot arm 10A includes a first arm 11 (arm), a second arm 12 (arm), a third arm 13 (arm), a fourth arm 14 (arm), a fifth arm 15 (arm), a sixth arm 16 (arm), six articulations 171 to 176 that have mechanisms supporting one arm to be rotatable with respect to the other arm (or the base stand 110), and a force detection unit 20, an inertial sensor 25, and an end effector 30A.

The base stand 110 and the first arm 11 are connected via the articulation 171 and the first arm 11 is rotatable about a first rotation axis O1 in the vertical direction with respect to the base stand 110. The first arm 11 and the second arm 12 are connected via the articulation 172 and the second arm is rotatable about a second rotation axis O2 in the horizontal direction with respect to the first arm 11. The second arm 12 and the third arm 13 are connected via the articulation 173 and the third arm 13 is rotatable about a third rotation axis O3 in the horizontal direction with respect to the second arm 12. The third arm 13 and the fourth arm 14 are connected via the articulation 174 and the fourth arm 14 is rotatable about a fourth rotation axis O4 perpendicular to the third rotation axis O3 with respect to the third arm 13. The fourth arm 14 and the fifth arm 15 are connected via the articulation 175 and the fifth arm 15 is rotatable about a fifth rotation axis O5 perpendicular to the fourth rotation axis O4 with respect to the fourth arm 14. The fifth arm 15 and the sixth arm 16 are connected via the articulation 176 and the sixth arm 16 is rotatable about a sixth rotation axis O6 perpendicular to the fifth rotation axis O5 with respect to the fifth arm 15.

Although not illustrated in FIG. 5, the plurality of driving units 130 and the plurality of position sensors 131 are installed in the articulations 171 to 176, respectively. The robot 1A includes the same number of (in the embodiment, six) driving units 130 and position sensors 131 as six articulations 171 to 176 (or six arms 11 to 16) (see FIG. 2).

In the embodiment, as illustrated in FIG. 5, a hand that had two fingers capable of grasping a component 83 as a target object is used as the end effector 30A.

The control unit 53 (see FIG. 2) included in the control device 5 has a function of performing gravity compensation in which an addition or a subtraction corresponding to a change in the attitude of the robot 1A is performed on a force output value (force detection information) of the force detection unit 20 so that an influence of the gravity is lost or reduced.

For example, the robot system 100A that has such a configuration can perform a work of transporting the component 83. Specifically, for example, the robot 1A can perform a work of grasping the component 83 (the target object) from a supply stand 93 and transporting the component 83 to a placement stand 94 that has a depression portion 941 opened on the lateral side under the control of the control device 5 (see FIGS. 5 and 6).

A target trajectory A2 illustrated in FIG. 6 is a route along which the tool center point TCP which is the tip end of the end effector 30A of the robot 1A in the above-described transport work is moved. In the embodiment, as illustrated in FIG. 5, the tool center point TCP is a point between the tip ends of the two fingers of the hand.

As illustrated in FIG. 6, in the above-described transport work, the control device 5 moves the tip end of the end effector 30A from the supply stand 93 in the +Z axis direction along the target trajectory A2 after grasping the component 83, and subsequently moves the tip end of the end effector 30A in the +X axis direction and moves the tip end of the end effector 30A in the −Z axis direction. Then, the component 83 is placed on the placement stand 94.

A point P1A on the target trajectory A2 is a point at which the component 83 on the supply stand 93 is grasped. A point P2A on the target trajectory A2 is a point at which the robot 1A lifts up the component 83. A point P3A on the target trajectory A2 is a point at which the component 83 is placed on the placement stand 94.

Hereinafter, the transport work of the robot 1A based on the control of the control device 5 will be described with reference to the work flow illustrated in FIG. 7.

First, the control unit 53 drives the robot arm 10A so that the tip end of the end effector 30A is located to the point P1A as in step S11 of the first embodiment (step S21).

Subsequently, the control unit 53 causes the end effector 30A to grasp the component 83 placed on the supply stand 93 as in step S12 of the first embodiment (step S22).

Subsequently, the control unit 53 drives the robot arm 10A so that the tip end of the end effector 30A is located to the point P2A as in step S13 of the first embodiment (step S23). Even in the embodiment, as in the above-described first embodiment, the tip end of the end effector 30A is moved from the point P1A to the point P2A at the first speed which is a relatively slow speed.

Subsequently, the control unit 53 resets the force detection unit 20 as in step S14 of the first embodiment (step S24).

Subsequently, the control unit 53 drives the robot arm 10A so that the attitude of the end effector 30A is changed from a state illustrated in FIG. 8 to a state illustrated in FIG. 9 (step S25). Specifically, as illustrated in FIG. 8, the attitude of the end effector 30A is changed from a state in which a central line 300 of the end effector 30A is located in a direction oriented in the vertical direction to a state in which the central line 300 is located in a direction oriented in the horizontal direction, as illustrated in FIG. 9. The changed attitude of the end effector 30A is the same as the attitude when the component 83 is placed on the placement stand 94.

Subsequently, the control unit 53 starts the gravity compensation (step S26). The gravity compensation may be started after the attitude of the end effector 30A is changed or may be started, for example, immediately before the component 83 is placed on the placement stand 94.

Subsequently, the control unit 53 drives the robot arm 10A so that the tip end of the end effector 30A is located to the point P3A as in step S15 of the first embodiment (step S27). Even in the embodiment, as in the above-described first embodiment, the tip end of the end effector 30A is moved from the point P2A to the point P3A at the second speed faster than the first speed.

Subsequently, the control unit 53 places the component 83 inside the depression portion 941 of the placement stand 94 (step S28).

In this way, the transport work by the robot 1A ends.

As described above, the control unit 53 performs the gravity compensation of the force detection unit 20 when the attitude of the end effector 30A which is the tip end of the robot arm 10A at the time of resetting the force detection unit 20 in step S24 is different from the attitude of the end effector 30A at the time of starting the force control in step S25. Thus, even when the attitude of the end effector 30A is different between the time of the resetting and the time of starting the force control, it is possible to improve the detection precision by the force detection unit 20. Therefore, it is possible to perform the transport work for the component 83 with high precision.

The control unit 53 can reset the force detection unit 20 based on one command, and change the attitude of the end effector 30, subsequently starts the gravity compensation, move the robot arm 10A at the second speed faster than the first speed, and perform the force control based on the output (force output value) from the force detection unit 20. That is, the operations of the robot 1A in steps S24 to S27 are performed based on one command. Thus, it is possible to improve readability and perform the plurality of processes simply and optimally.

In the embodiment, the force detection unit 20 is reset before the attitude of the end effector 30A is changed in step S25. However, the force detection unit 20 may be reset after the attitude of the end effector 30A is changed. In this case, the gravity compensation may not be performed.

Even in the above-described robot system 100A, it is possible to obtain the same advantages as those of the robot system 100 in the above-described first embodiment.

The control device, the robot, and the robot system according to the invention have been described above according to the illustrated embodiments. However, the invention is not limited thereto and the configuration of each unit can be substituted with any configuration that has the same function. In the invention, any other constituents may be added. The embodiments may be appropriately combined.

The number of rotation axes of the robot arm is not particularly limited. For example, the number of rotation axes may be 4, 5, or 7 or more. The number of robot arms is not particularly limited and two or more robot arms may be used.

In the above-described embodiments, the example in which the force detection unit is installed at the tip end of the robot arm has been described. However, a portion in which the force detection unit is installed may be any portion as long as a force or a moment applied to any portion of the robot can be detected. For example, the force detection unit may be installed at the base end of the sixth arm (between the fifth and sixth arms).

The entire disclosure of Japanese Patent Application No. 2016-219470, filed Nov. 10, 2016 is expressly incorporated by reference herein.

What is claimed is:

1. A control device comprising:
a processor that is configured to execute computer-executable instructions so as to control a robot that includes a robot arm including a force detector,
wherein the processor is configured to reset the force detector after moving the robot arm at a first speed, and subsequently moves the robot arm at a second speed faster than the first speed and performs force control based on an output from the force detection unit.

2. The control device according to claim 1,
wherein the second speed is equal to or greater than 50 mm/s.

3. The control device according to claim 2,
wherein the first speed is equal to or less than 20 mm/s.

4. The control device according to claim 1,
wherein the second speed is equal to or greater than 200 mm/s.

5. The control device according to claim 4,
wherein the first speed is equal to or less than 80 mm/s.

6. The control device according to claim 1,
wherein the second speed is 2.5 times or more the first speed.

7. The control device according to claim 6,
wherein the second speed is 10.0 times or more the first speed.

8. The control device according to claim 1,
wherein the processor is configured to perform control such that the robot holds a target object before resetting the force detection unit.

9. The control device according to claim 1,
wherein the processor is configured to perform the movement of the robot arm at the first speed and the movement of the robot arm at the second speed according to each position control.

10. The control device according to claim 1,
wherein the processor is configured to perform the force control without stopping the robot arm after moving the robot arm at the second speed.

11. The control device according to claim 1,
wherein the processor is configured to perform control such that an attitude of a tip end of the robot arm at the time of resetting the force detector is the same as an attitude of the tip end of the robot arm at the time of starting the force control.

12. The control device according to claim 1,
wherein the processor is configured to perform gravity compensation of the force detector when an attitude of a tip end of the robot arm at the time of resetting the force detection unit is different from an attitude of the tip end of the robot arm at the time of starting the force control.

13. The control device according to claim 1,
wherein the processor is configured to reset the force detector based on one command, and subsequently move the robot arm at the second speed faster than the first speed and performs the force control based on an output from the force detector.

14. A robot that is controlled by the control device according to claim 1.

15. A robot that is controlled by the control device according to claim 2.

16. A robot that is controlled by the control device according to claim 3.

17. A robot that is controlled by the control device according to claim 4.

18. A robot system comprising:
the control device according to claim 1; and
a robot that is controlled by the control device and includes a robot arm including a force detection unit.

19. A robot system comprising:
the control device according to claim 2; and
a robot that is controlled by the control device and includes a robot arm including a force detection unit.

20. A robot system comprising:
the control device according to claim 3; and
a robot that is controlled by the control device and includes a robot arm including a force detection unit.
